(19) United States
(12) Patent Application Publication
(10) Pub. No.: US 2026/0233984 A1
(43) Pub. Date: Aug. 13, 2026

(54) ENERGIZABLE ADJUSTABLE CLAMP APPARATUS AND METHOD FOR EXTRACTING LIQUID FROM CONTAINERS

(71) Applicant: J. Nicholas and Kristin Gross Trust U/A/D April 13, 2010, Berkeley, CA (US)

(72) Inventor: John N Gross, Berkeley, CA (US)

(21) Appl. No.: 19/350,028

(22) Filed: Oct. 5, 2025

Related U.S. Application Data
(60) Provisional application No. 63/703,345, filed on Oct. 4, 2024.

(51) Int. Cl. B67D 3/00

(52) U.S. Cl. CPC B67D 3/0029

(57) ABSTRACT

An apparatus adapted to remove liquids from containers is disclosed, with active energy delivery elements designed to dislodge and cause movement of the material within the container using vibrational energy to overcome viscosity. The apparatus includes an energizable clamp structure with flexible structural fingers that position and secure a container with a claw-type grip. The fingers include vibration elements to deliver vibrational energy to a container in an efficient manner and shake loose hard to remove material collected in the container. Additional heating elements can be employed to reduce viscosity and improve flow as well. During an activation mode electrical energy can be used to power the vibration elements such that controlled and continuous removal of material can be achieved. The clamp can include a base as well.

### RELATED APPLICATION DATA

The present application claims the benefit under 35 U.S.C. 119(e) of the priority date of Provisional Application Ser. Nos. 63/703,345 filed Oct. 4 2024 which is hereby incorporated by reference.

### FIELD OF THE INVENTION

The present invention generally relates to the field(s) of fluid extraction technology from containers. More specifically, embodiments of the present invention pertain to an energizable clamp apparatus and method for helping remove food items, cosmetic items, toiletry items, and similar household liquids from small bottles having different compositions using vibrational and/or heat energy.

### BACKGROUND OF THE INVENTION

Liquid-based products are distributed in multiple container forms as seen in FIG. 10A, which depicts a number of shapes and sizes for contemporary materials, ranging from shampoo (a cleaning liquid) to ketchup (a food condiment liquid). It will be understood that other liquids/containers are available in commerce and that this is merely a cross section of some common forms.

A common problem that arises with liquids is depicted in FIG. 10B. In particular, the viscosity of fluids changes (i.e. typically increases) over time due to multiple different factors, including temperature, gravity, water loss, etc., which makes it more difficult to remove them from such containers as they do not flow easily from such articles. The nominal room temperature of a number of common liquids is shown in FIG. 10D, and as can be seen ranges by a factor of more than a 1000.

The problem of dispensing fluids is exacerbated when the containers are refrigerated (as is a common requirement with certain foods) as this typically increases viscosity and reduces ease of flow as shown in the chart of FIG. 10E in the example of Ketchup. Over time, as seen in FIG. 7D, material migrates to the bottom of the container where it becomes condensed, thicker, etc .. As seen in FIG. 10B, a typical container 170 (which may be cylindrical, rectangular, etc.) with sidewalls 172 storing liquid 180 may be stored in an upright position (i.e. with a first side 171 on the bottom, and a sealable cap situated on top of a second side 173. To extract the fluid 180, which may have a high viscosity because the material is cold, and has become condensed and thicker, a consumer is typically required to flip container 170 and then manually tap or apply an impulse to bottom surface 171 to break the surface tension and induce flow along the interior sidewalls 172 as depicted by the green arrow. Over time and with repeated manual force the fluid 180 moves along the sidewalls and the consumer can (ideally) force at least some of it into or in a region near cap 174 so that it can be dispensed by tapping, squeezing, etc. Even using this approach it is extremely difficult to remove all the material from the sidewalls.

Another trick that is sometimes employed is that consumers will invert container 170 and simply rely on gravity, time and shearing forces to achieve some measure of flow. Note that it is not always desirable or possible to store container 170 in this inverted position as there is frequently leakage of liquid 180 resulting in loss of material and messy cleanup work. Moreover some containers have irregular shaped caps or tops and cannot be balanced securely in an upside down position.

The prior art manual and/or passive techniques therefore are known to be imperfect, and frequently the case that consumers are not able to extract a particular liquid within a reasonable time (or at any time) after they access it for a particular purpose. Even after the material 180 is moved within the container, it can be difficult to control as a result of it immediately dumping in undesired amounts after the cap 174 is removed.

In addition, containerized liquid-based products are commonly discarded with useable contents remaining inside. This undesired outcome regularly occurs after a consumer, through exhaustion of efforts in timely and reasonable container handling and movement (as discussed above), is no longer able to expel any more of the contents and results in material being wasted and, thus, possible frustration by the end user over the diminishment of the product's utility.

Product manufacturers attempt to mitigate this problem by designing containers in ways that increase evacuative influences. For example, the famous Heinz Ketchup bottle includes instructions to consumers to tap it at a specific embossed spot identified as 57 on the sidewall. As seen in FIG. 10C, other attempts to maximize the amount of extrapolation of materials from a container involve fitted attachments 172 or augmentation, including as taught in USD Patent 755627 incorporated by reference herein. Such designs and additions are limited in their ability to impose a broad influence on the widely varying content compositions and container sizes. This leads to an unfulfilled need for a more indiscriminate solution.

Other art in the liquid container field includes U.S. Pat. No. 9,967,924, which illustrates an RF induction heater for fluids, U.S. Pat. No. 5,794,904, and USD 435,711 which describe inverted bottle holders, U.S. Pat. No. 5,080,150 which shows a passive bottle draining basket, US Pub. No. 2010/0314418 and U.S. Pat. No. 10,131,473 which describe improved dispensers, US Pub. No. 2014/0332477 which describes a funnel, US Pub. No. 2012/0305598 and U.S. Pat. No. 6,684,922, which describe passive draining devices, US RE37,566 which describes a flexible holding device, all of which are hereby incorporated by reference.

None of these innovations, however, provide a satisfactory solution to the problems above.

Consequently, there is a long felt need for improved devices and methods for extracting liquid from containers beyond the solutions offered to date, to reduce waste, time, and consumer frustration. This “Discussion of the Background” section is provided for background information only. The statements in this “Discussion of the Background” are not an admission that any particular subject matter disclosed in this “Discussion of the Background” section constitutes prior art to the present disclosure, and except for those portions specifically identified as prior art no part of this “Discussion of the Background” section may be used as an admission that any part of this application, including this “Discussion of the Background” section, constitutes prior art to the present disclosure.

### SUMMARY OF THE INVENTION

An aspect of the present disclosure therefore is to provide systems and methods which address the limitations in the prior art noted above.

A first aspect of the disclosure pertains to an apparatus (and associated method) that facilitates movement and flow of a liquid material in a container to make it more easily and quickly dispensable compared to prior art techniques.

A second aspect of the disclosure pertains to an apparatus (and associated method) that increases an absolute amount of starting liquid material dispensed from a container.

A third aspect of the disclosure relates to an apparatus (and associated method) that increases control of liquid as it is dispensed from a container.

A fourth aspect of the disclosure relates to employing vibrational energy, heat energy, or a combination thereof, to reduce viscosity of a liquid and/or increase flow within a container to increase ease/control of material removal.

These and other aspects of the inventive embodiments are described in detail below. It will be understood and appreciated by skilled artisans that not all embodiments of the invention need incorporate all aspects as described above, and that the scope of the invention(s) herein is/are defined exclusively with reference to the claims set out below.

### DESCRIPTION OF THE DRAWINGS

FIG. 1 shows a first embodiment of an energizable liquid extraction apparatus which includes a screw-based clamp with energizable vibrating elements to secure and facilitate removal of material from a container positioned and secured within;

FIG. 2A shows a first side view of a first embodiment of a liquid extraction apparatus which incorporates a twist-handle adjustable sized clamp with embedded vibrational elements and optional heating and fastening elements which secure and automatically facilitate removal of material from a container;

FIG. 2B shows a second opposite side view of the first embodiment;

FIG. 2C shows a top side view of the first embodiment;

FIGS. 2D and 2E show variants of a clamp claw-type holding member that can be used in embodiments of the present disclosure;

FIG. 2F illustrates the securing of a typical container for treatment by the first embodiment using activatable vibration elements;

FIG. 2G depicts a variant of the first embodiment including an optional extended base structure and additional vibration elements;

FIG. 2H depicts a variant of the first embodiment including flat vibration elements and embedded reverberation elements;

FIG. 3A shows a back side view of a second embodiment of a liquid extraction apparatus which includes a spring-based clamp with energizable vibrating elements to secure and facilitate removal of material from a container positioned and secured within;

FIG. 3B shows a front facing view of the second embodiment;

FIG. 3C shows a side view of the second embodiment;

FIG. 3D shows a top side view of the second embodiment;

FIG. 3E illustrates the securing and treatment operation for a typical container by the second embodiment using activatable vibration elements;

FIGS. 4A and 4B show an embodiment of an electrical control circuit and control panel respectively used in implementations of the described apparatuses;

FIG. 5 depicts a variant of the first embodiment of an energizable clamp which includes a a pair of opposing clamp members for securing a container;

FIG. 6 illustrates a variant of the second embodiment which includes an optional base structure for enhancing a vibration process to extract fluid;

FIG. 7A shows a structural overlay of the active elements (including vibrational and optional heating elements) of a liquid extraction apparatus engaging with surfaces of the container during an activation mode to move material therein;

FIG. 7B shows the movement of material in sidewalls of the container during an activation mode;

FIG. 7C visually depicts the migration and change of position of material in a container over time as effectuated by embodiments of the disclosure, and associated changes in light detection as a result thereof;

FIG. 7D visually depicts settling of a typical material in a container as occurs naturally over time;

FIGS. 8 and 9 depicted alternative embodiments in which the key features of the invention are integrated into large and small appliances respectively;

FIG. 10A identifies a number of different types of containers for different types of liquid materials;

FIG. 10B identifies a conventional manual technique for extracting liquid materials from a container;

FIG. 10C identifies a number of prior art passive gravity solutions for extracting liquid materials from containers;

FIG. 10D is a list identifying the viscosity of a number of common liquids at room temperature;

FIG. 10E is a chart identifying the viscosity of a typical ketchup composition over a wide range of temperatures.

### DETAILED DESCRIPTION

Reference will now be made in detail to various embodiments of the invention, examples of which are illustrated in the accompanying drawings. While the invention will be described in conjunction with the following preferred embodiments, it will be understood that the descriptions are not intended to limit the invention to these embodiments. On the contrary, the invention is intended to cover alternatives, modifications and equivalents reasonably understood by persons of ordinary skill in the art to be included within the spirit and scope of the invention. Furthermore, in the following detailed description, numerous specific details are set forth in order to provide a thorough understanding of the present invention. However, it will be readily apparent to one skilled in the art that the present invention may be practiced without these specific details. In other instances, well-known methods, procedures and components have not been described in detail so as not to unnecessarily obscure aspects of the present invention. Furthermore, it should be understood that the possible permutations and combinations described herein are not meant to limit the invention. Specifically, it will be understood by those skilled in the art that variations that are not inconsistent may be mixed and matched as desired.

As discussed above, bottles and other containers are used for storing any number of household consumable (e.g. condiments, sauces, toppings, spread, etc.) and non-consumable (soaps, shampoos, lotions, etc.) liquids having different viscosities.

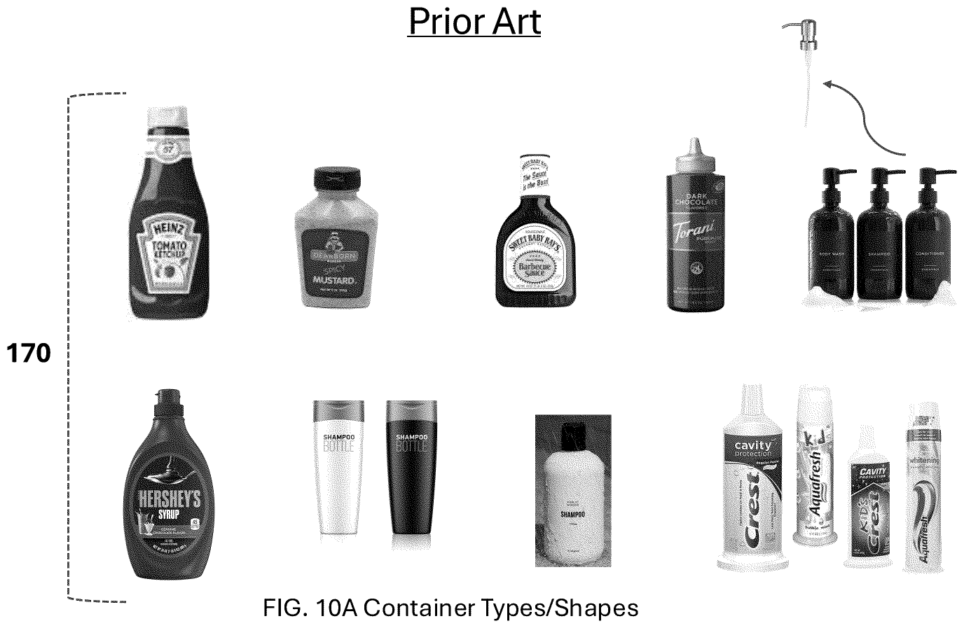

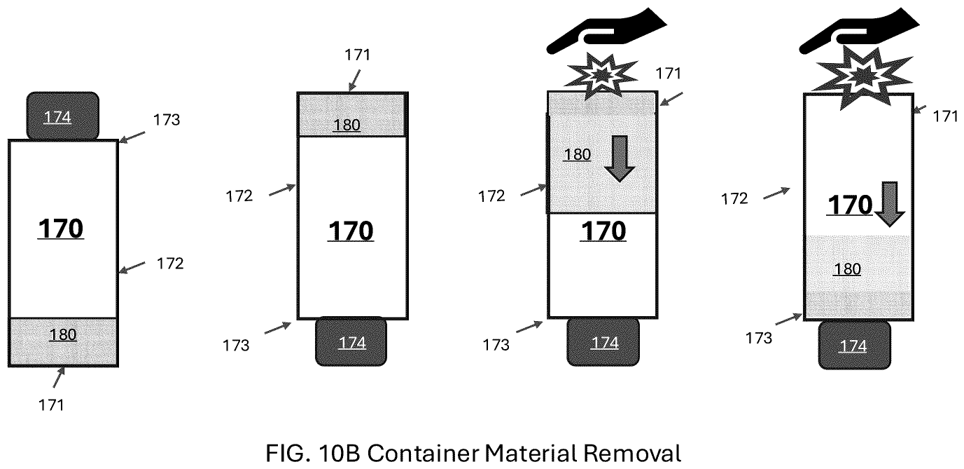

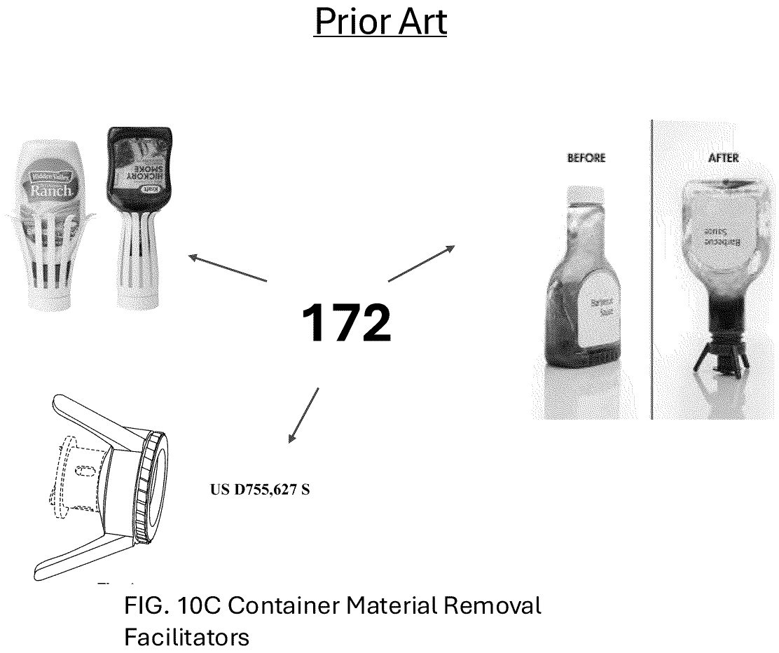

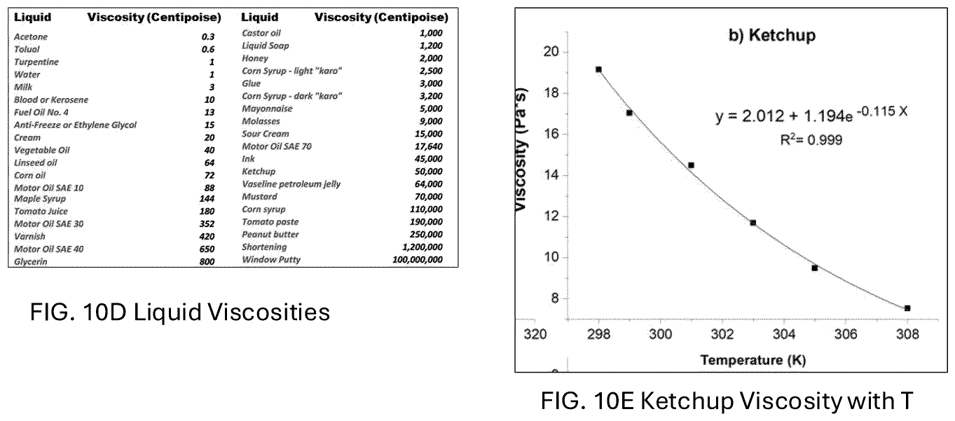

FIG. 10D shows that these liquids can have very low viscosity, like water (V=1 Centipoise) to liquids like Peanut Butter with a very high viscosity (V=250,000). The viscosity of a fluid is a measure of its resistance to deformation or flow at a given rate. Colloquially this is referred to as “thickness,” meaning for example that typically molasses is considered “thicker” than milk as seen in the FIG. 10D table.

The magnitude of the viscosity of a fluid directly affects how easily it flows out of a container. This is why it easier to pour water (low viscosity) out of a bottle than ketchup (high viscosity). To make a fluid flow out of a container therefore, one can either change/reduce the viscosity of the material to make it more easily flowable, and/or apply sufficient force to overcome the deformation resistance. For some fluids, as is known from direct experience, the resistance can be overcome simply by turning the bottle upside down to cause it to move from the bottom of the bottle to the neck. This is the technique used in the prior techniques, which rely on gravity as the force to act on the liquid surface over time, or vigorous manual shaking.

Embodiments of the present invention as discussed herein use other controllable applied energy and forces—preferably in the form of vibrational energy powered from an electrical source—to overcome the liquid viscosity beyond just passive gravity and manual shaking. Vibrational energy is provided to one or more surfaces of the container (top, bottom, sides, etc.), which has the effect of both heating the material to reduce viscosity, and through such added force combined with gravitional force, is sufficient to overcome any flow resistance and cause the material to flow to the bottom of the container for easier dispensing. The amplitude and frequency of vibrational energy can be controlled easily using conventional techniques to allow for a wide range of extractions of different types of materials from any type of container.

Viscosity is affected by other influences and factors as well, including temperature. This is seen in FIG. 10E. Higher temperature decreases the viscosity of fluids due to the increased kinetic energy of the molecules. Raising the temperature of some liquids too much however is undesirable as it will compromise their composition, taste, etc. Accordingly, any heating of a container to reduce viscosity preferably should be done in the smallest area for the shortest period of time, and at a temperature that is below that which could impair the texture, taste, longevity, etc. of the material in question.

In selected embodiments of the present invention heat energy therefore is also exploited to reduce viscosity selectively in areas (e.g. typically proximate to a sidewall surface) of a container. This has the effect of causing flow of the material at the interface to the sidewall, bringing about an avalanche effect with the rest of the material. This additional heat energy is preferably applied in a controllable area, for a predefined time and at a predetermined temperature that is tailored to the container, material, etc.

Pressure also affects viscosity for some types of fluids such as Ketchup, which is considered a non-Newtonian fluid because its viscosity is dependent on shear rate. When materials like ketchup are squeezed, they can be extracted faster because the viscosity decreases as it yields to pressure. This behavior is called shear thinning and is caused by polymers that are added to the liquids as a thickener. For most liquids, too, there is a certain amount of stress that needs to be overcome before it will flow. In some embodiments of the invention the vibrational energy applied to flexible sidewalls can effectuate a limited form of “squeezing” to apply pressure in the same way to bring about the same result.

Furthermore viscosity is also affected by changes in the composition of the material as a result of environmental factors. For liquids like Ketchup, mustard, etc., water or other ingredients (like vinegar) can “leach”-separate out and cause a portion of the mass to dry out and become more viscous; this is noticeable when a container is turned upside down and the first material to flow is water/vinegar, etc. The most common technique to fix this again is to shake the container to homogenize the ingredients. Embodiments of the present invention can effectuate the same kind of viscosity reduction and increased homogenization through vibrational energy.

All reference numbers used herein correspond to the same structure in each figure unless otherwise indicated.

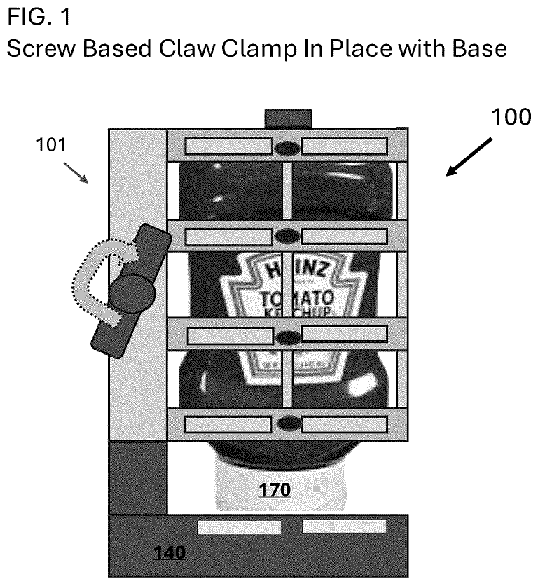

FIG. 1 shows a first embodiment of a liquid extraction apparatus 100 which employs an energizable clamp 101 mounted on an optional base 140 and electrically powered to facilitate removal of material from a container 170 positioned and secured within.

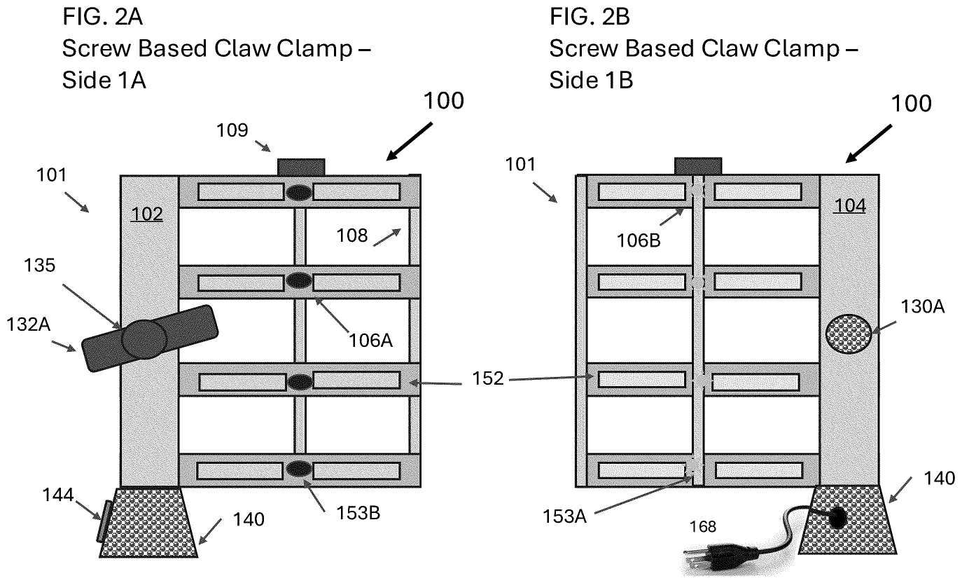

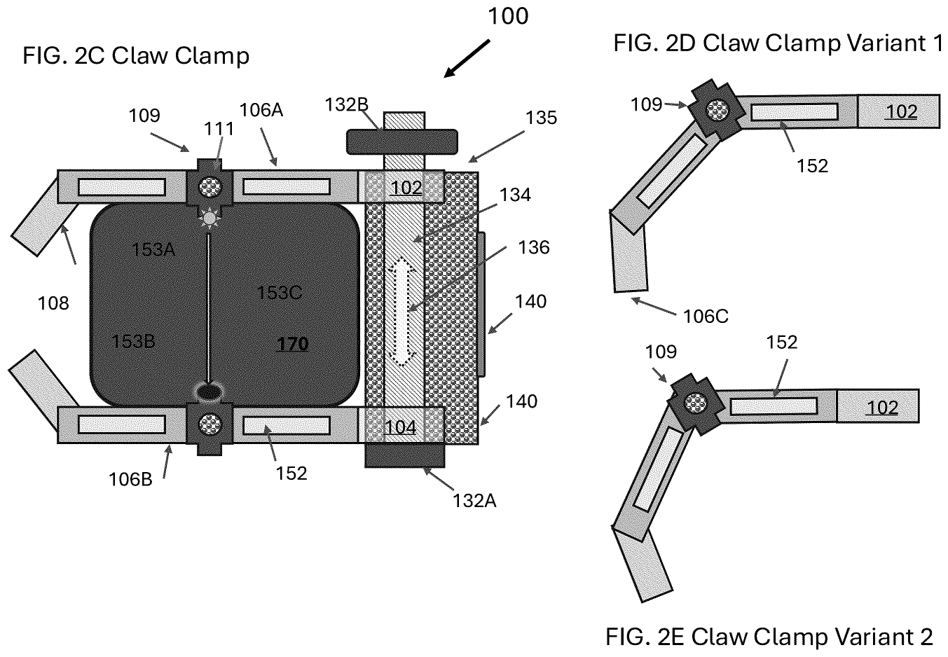

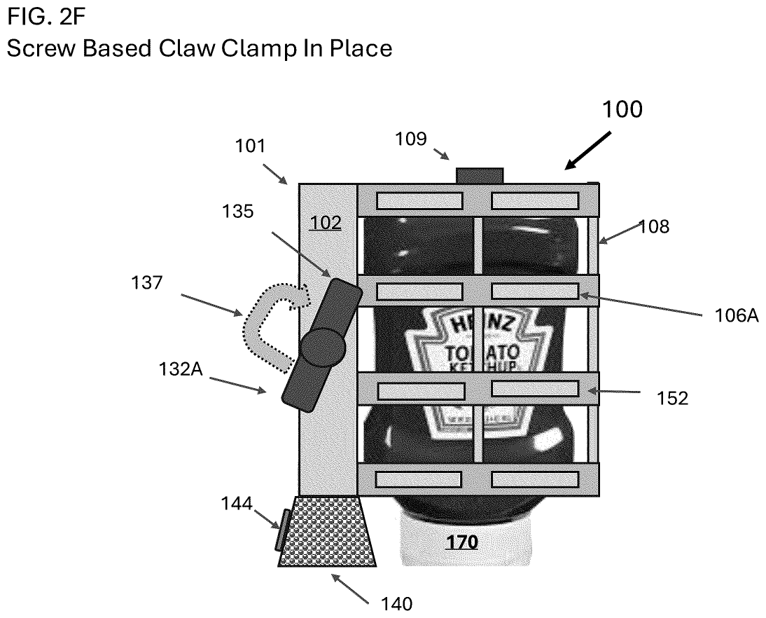

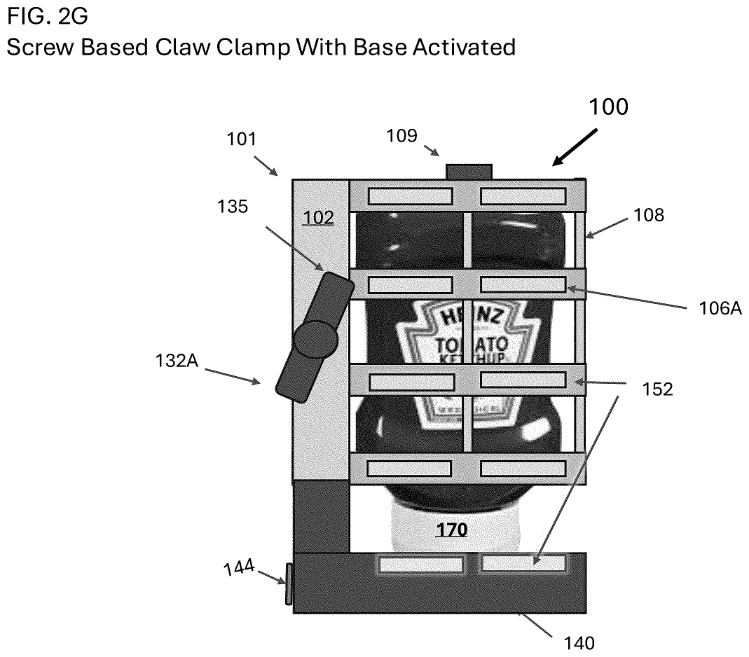

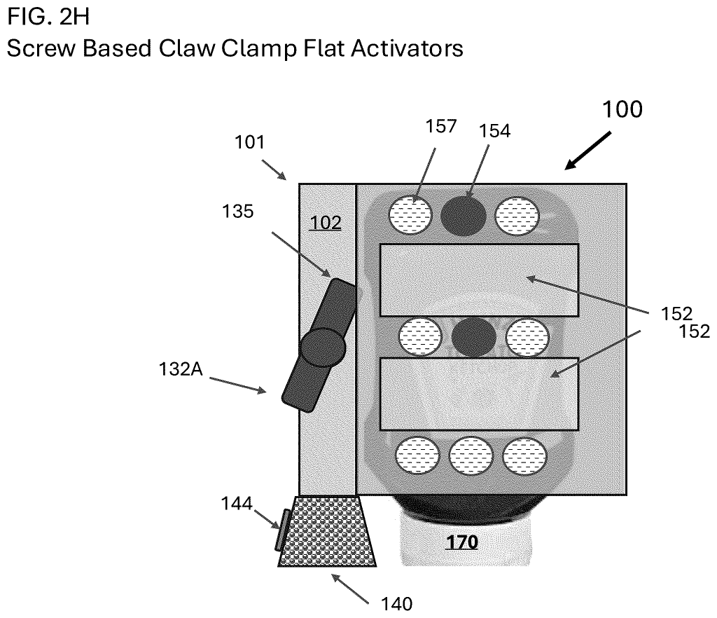

FIG. 2A/2B show side exterior views of a first embodiment of a liquid extraction apparatus 100 which incorporates an energizable screw-based clamp or vise assembly 101 with an integrated base 140 to move material in a container 170 using vibration energy and optional heat energy. The energizable screw-based clamp 101 includes dual opposing body sections or members 102/104, flexible finger segments or sections 106A/106B, and cross section members 104. The body sections/members 102/104, which are preferably rigid and made of a material such as metal, hard plastic, or other conventional material, may be loosely sitting on top of base 140, or within a track, and include some form of channel (not shown) to accommodate electrical wiring to the claw clamp assembly. A screw assembly 135 includes a screw member 134 (FIG. 2C) which threads through body posts or members 102 and 104, with a cap 130A at one end, and 31 a turnable handle 132A (shaped like a conventional can opener handle) at the other end. Twisting of handle 132A forces loose opposing body members clamp to close like a vise through the screw mechanism to contact and secure a solid container, as seen in FIG. 2C. In this clamp assembly configuration, the clamp is open by default in a first open position, and is closed manually to secure a container in a second closed position.

The energizable screw-base claw clamp or vise further includes integrated vibrational elements 152 and optional heating elements (not shown) to deliver vibrational energy to automatically facilitate removal of material from a container. A series of sensor/detection pairs 153A/153B are mounted on finger sections 106/108, with one active directed light source 153A providing a reference light beam passing through the container, which is detected by a second passive detector 153B on the opposite side. Power for the apparatus can be supplied by an AC source through plug 168 and/or through batteries (including rechargeables) that can be located in a base body 140. A control panel 144 is accessible to users for implementing a desired set of operating parameters for an activation mode.

This claw arrangement permits energy to be delivered to the container through at either or both of a first container surface and second container surface (by way of the embedded vibration elements in the finger elements) to assist and facilitate movement of the volume of fluid from a first bottom end of the container to a second top end of the container.

FIG. 2C shows an overhead view of the first embodiment of the energizable screw-based clamp apparatus. The screw assembly 135 operates using a screw 134 that threads body portions 102/104, and is sized and configured so that turning handle 132b forces member 102 to move down as shown by arrow 136. Body portion 104 is preferably fixed in place, so that a cap member 132A secures one end of the screw 134 and is immobile. The vertical movability of body member 102 is enabled by moving it up and down; when a container 170 is place between opposing clamp members 106A, 106B, it can be secured in place by turning handle 132B to cause it to move down a thread of screw 134 and lock container 170 securely in place. A conventional bar clamp assembly (not shown) can be modified to mimic this structure and be used as well. As noted earlier, the body portion 102 can be in a track, and includes a channel for routing electrical cabling from base 140 to power and control the vibration elements 152. The inner surface 108 of the flexible finger 106 thus makes a tight contact to container 170 so that energy can be imparted to sides of container 170 through the sidewalls of the fingers. The vibration elements are preferably situated within and near a surface 108 of finger 106 to increase efficiency of energy delivery. A joint hinge assembly 109 permits the flexible fingers 106 to rotate and grip different sized containers, similar to that found in other conventional robotic hand grips.

The material detection assembly combination 153A/153B is also shown, with a light beam 153C being transmitted (153A), attenuated by material in container 170, and measured at detector 153B, at differing heights with the clamp to identify a change in position of material in the container.

Additional embodiments of flexible fingers 106 for a clamp apparatus are shown in FIGS. 2D and 2E which may be preferable for some applications. The flexible finger members 106 may be have differing lengths, different numbers of segments or sub-members, different joint 109 locations for the segments, different ratios in the segment or sub-member sizes (e.g. the section from 102 to 109 may be longer than that from 109 to the finger tip 106C) etc. Any number of variants will be apparent to those skilled in the art depending on the intended application.

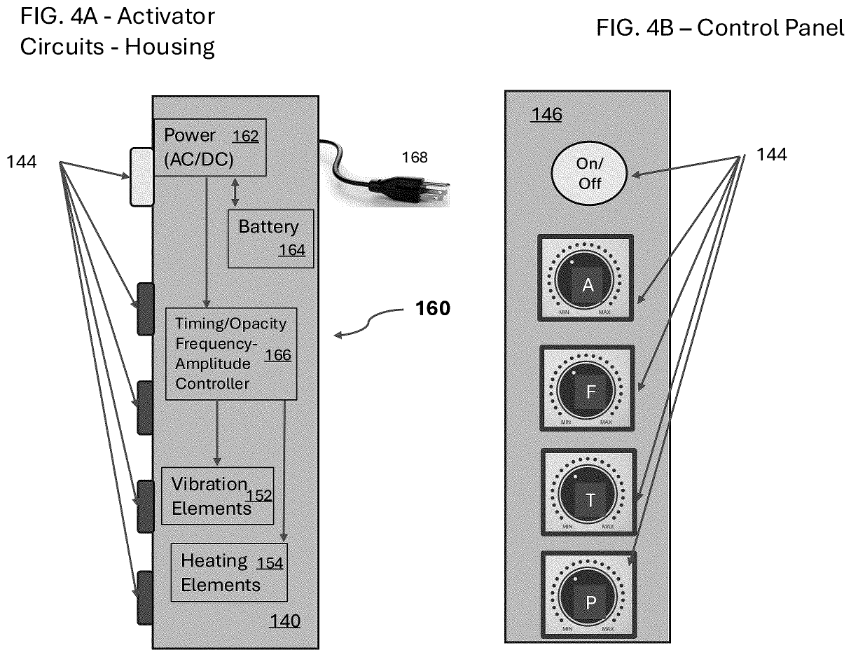

FIG. 2F illustrates the securing of a typical container for treatment by the first embodiment using activatable vibration elements. The handle 132A is turned in a clockwise direction 137 so that the screw mechanism 135 closes clamp 101 and causes tight contact by fingers 106A to a surface of container 170. The unit is then activated through controls on panel 144, causing vibrations elements 152 to vibrate and induce movement of fluid within container 170. The apparatus 100 includes a base 140 for securing clamp 101 and container 170 on a solid surface, and preferably housing the power and control circuitry shown in FIGS. 4A and 4B. An adjustable hinge 109 allows the fingers 106 to be opened and closed at joint positions to improve contact with different shaped containers.

FIG. 2G depicts a variant of the first embodiment including an optional extended base structure 140 and additional vibration elements 152 situated on a top surface therefore to increase an amount of energy delivered to container 170 through a neck/cap portion. This combination of vibration energy provided through two separate vibration elements to two different portions of container 170 facilitates the movement and removal of material.

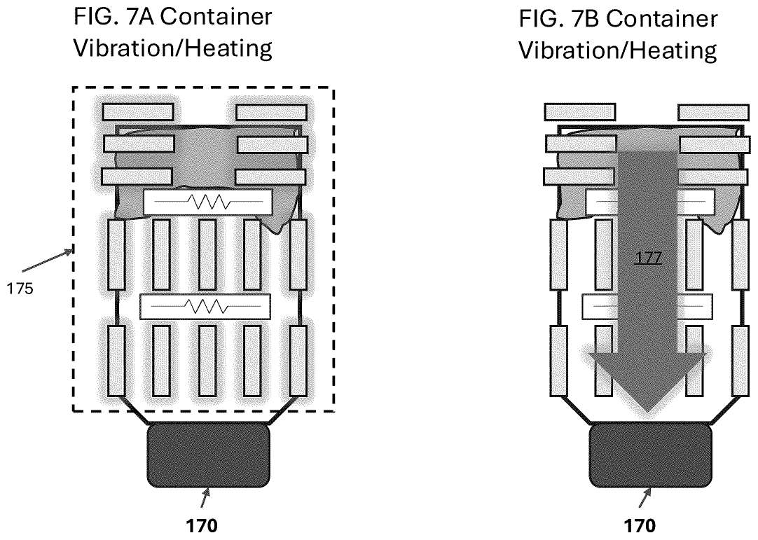

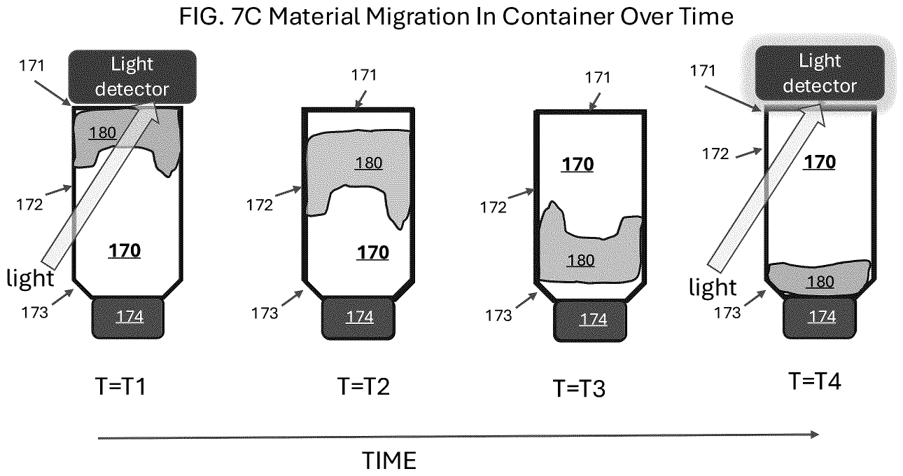

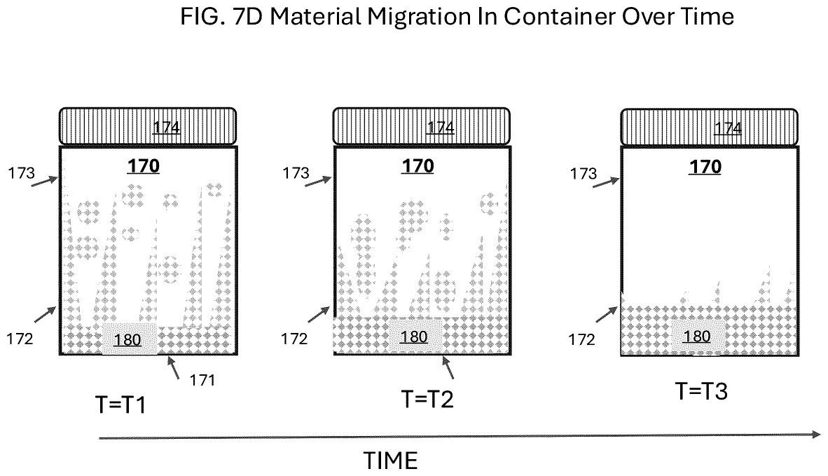

FIG. 2H depicts a variant of the first embodiment including flat vibration elements 152, heating elements 154, and embedded reverberation elements 157. In this approach the vibration elements 152 are configured to contact a larger surface area with more distributed energy. Other forms and examples of vibration elements 152, which are preferably some form of piezoelectric elements (electrically activable diaphragms) will be apparent to those skilled in the art. The reverberation elements 157 help to prolong and amplify the effects of the vibration elements 152 in imparting energy to the sidewalls of a container 170. As the container sidewalls 172 (see FIG. 7C) vibrate they impact the solid stationary elements 157, which creates a counterforce that further operates to dislodge material on the inside of container 170.

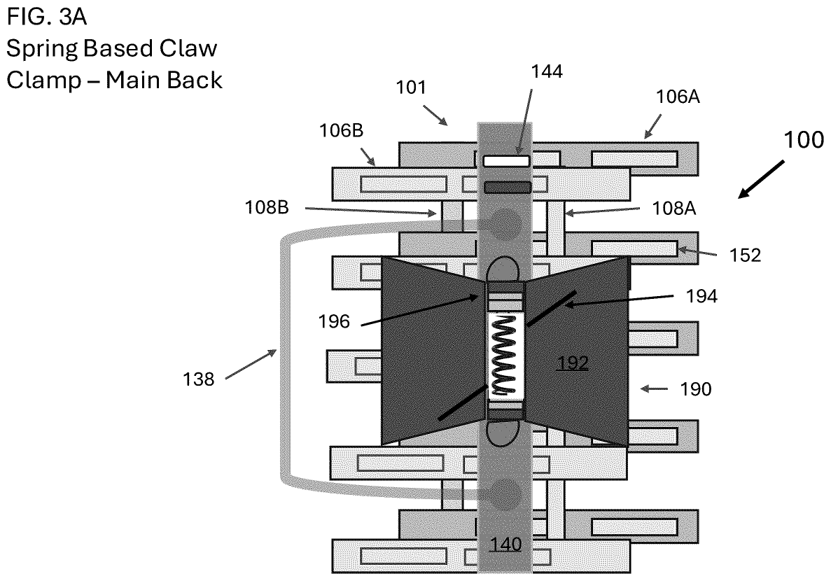

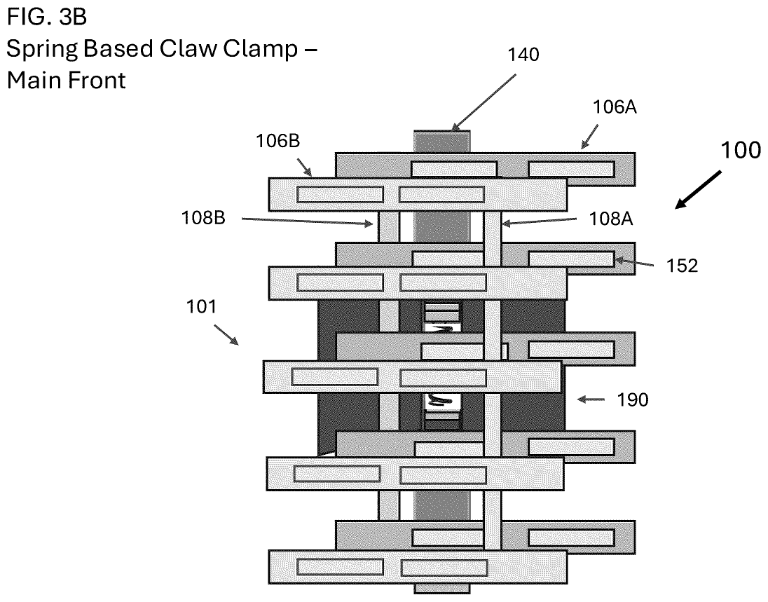

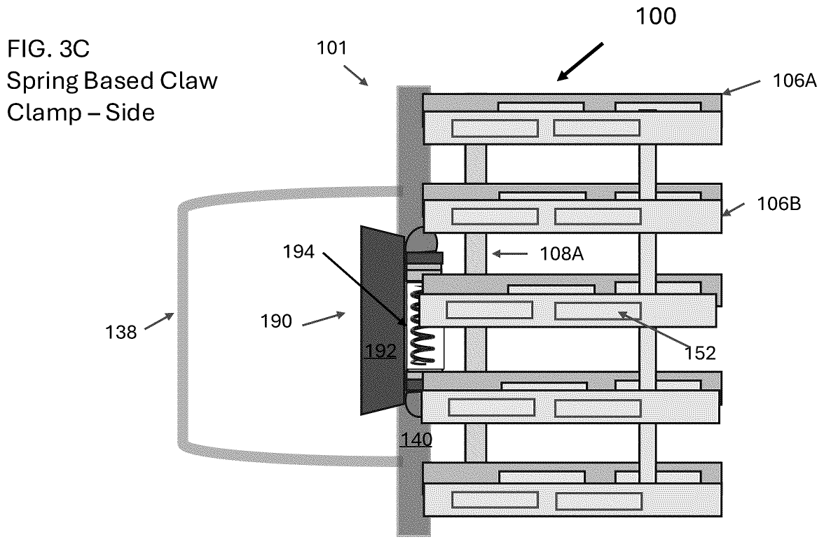

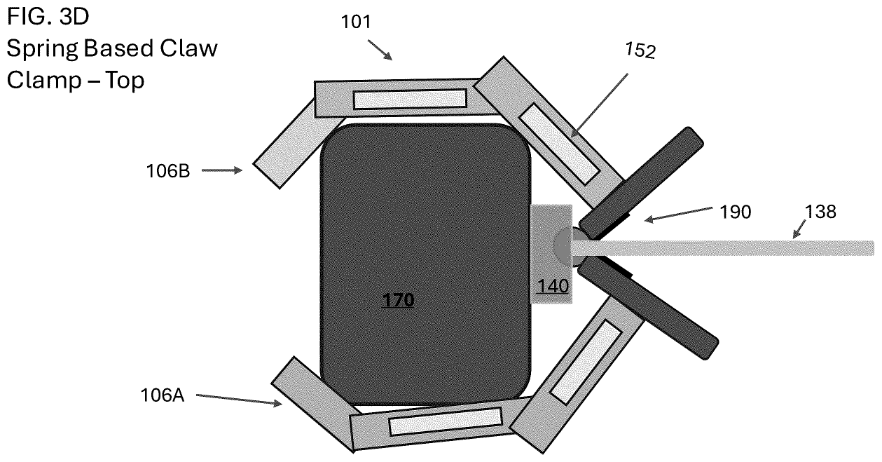

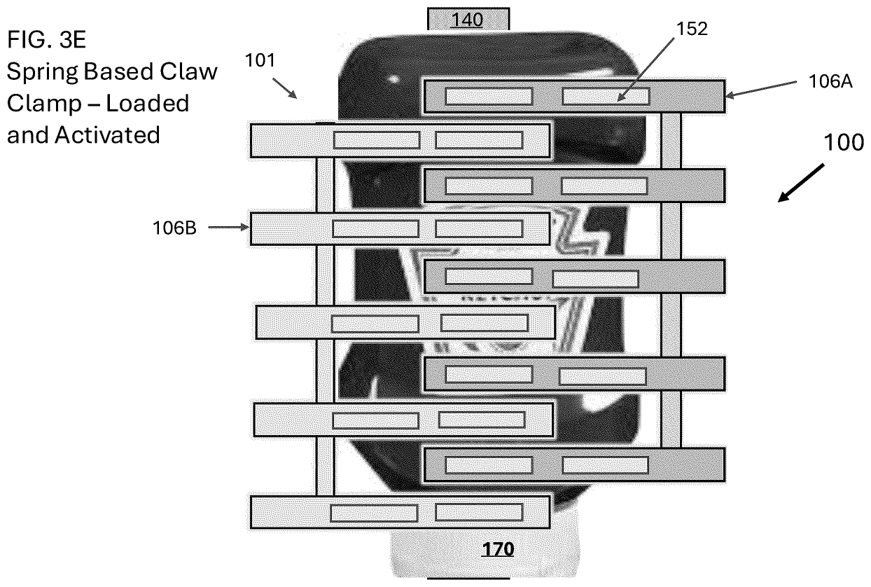

FIG. 3A shows a back side view of a second embodiment of a liquid extraction apparatus 100 which includes a spring-based clamp 101 with energizable vibrating elements 152 to secure and facilitate removal of material from a container positioned and secured within. In this embodiment, rather than a screw assembly, a spring assembly 190 provides a biasing force to close flexible fingers 106A and 106B to make contact with a container in a first default position. This structure is similar to that found in a number of consumer products, including hairclips for example, albeit modified to have significantly greater bias force to make good contact between fingers 106A/106B and a container.

A bias/spring assembly 190 includes a pair of solid winged members 192, which are sculpted, shaped and sized to be easily manipulable by an operator using manual action. In other words, the opposing left and right edges can be pinched together by an operator using his/her hand to counter a bias spring 194 and open the claw into a second open position, and then be released to allow the spring 194 to apply pressure and bias the fingers closed. Spring 194 is kept in place along a solid stem assembly 196 that includes a rigid cylinder (or other shape) about which the former wraps around in a known arrangement. The assembly 196 is capped at both ends to secure spring 194 in place.

The spring assembly 190 is mounted and attached to a solid body 140 which is adapted to house a portion of the former while allowing flexible movement of wing members 192. Body 140 houses all the power and control electronics, which are enabled by controls on a panel 144 as in the first embodiment. Body 140 may also include facility for one or more batteries (not shown) and channels (not shown) for routing electrical wiring to the vibration/energy elements in fingers 106A/106B. The clamp assembly 101 can be held by a human operator during operation by way of handle 138, which is also preferably mounted or attached to body 140.

FIG. 3B shows a front facing view of the second embodiment as it would appear in closed form, prior to securing a container for treatment. The clamp finger members 106A/106B on opposing sides of the clam are spaced horizontally and interlaced as shown to provide a more compact form and control over smaller containers. As in the prior embodiment, vertical support members 108 are also employed to create a rigid frame for the clamp to deliver vibrational energy to a container. This second embodiment effectively uses the reverse securing scheme of the first embodiment, in that the claws in the second embodiment are closed by default in a first position, while the clamp in the first embodiment is open by default in a first position. Active force is required to open the claws into an open position to accept and then secure a container.

FIG. 3C shows a side view of the second embodiment. The shape, sizing of wing members 192 and composition/bias of spring 194 can be selected through routine skill in the art to allow a human operator to open them and accommodate different types of containers and apply sufficient vibrational energy to effectuate efficacious treatment of such. The horizontal separation and interlacing of finger members 106A and 106B is shown here as well, with shading given for the latter to better identify the presence of internal vibrating elements 152.

FIG. 3D shows a top side view of the second embodiment of apparatus 100 as it would be employed to hold and secure a container 170 so as to deliver vibrational energy through elements 152. The claw fingers 106A, 106B are adapted with a shape that permits them to surround and contact a surface of container 170 to impart vibrational energy. Body 140 is shown in shaded form to illustrate how a spring mechanism 190 can be mounted thereto to allow for biasing the clamp open. Spring 192 then biases the clamp shut cause the clamp to make firm contact with container 170.

FIG. 3E illustrates the securing and treatment operation for a typical container 170 by the second embodiment using activatable vibration elements 152. The finger elements 106A and 106B extend over a significant areal portion of a surface of container 170 to increase an amount of vibrational energy to such item.

It will be understood from the present description that the number, arrangement and interaction of the finger elements 106 can be implemented through several similar satisfactory arrangements. Persons skilled in the art will appreciate that a large assortment of known vibrating elements 152 and heating elements 154 can be employed in embodiments of the present disclosure. To wit, the vibrating elements 152 may be numbered, shaped (planar, cylindrical, etc.) and sized to be powered by a low voltage energy source (e.g., regular batteries, rechargeable batteries, etc.). The heating elements 154 can be of a resistive type used in other conventional consumer devices, but with increased allowance of energy output since the application is not intended for contact with human skin.

As seen in FIG. 4A, to supply the power for the energy delivery elements 152/154, a DC or AC source 162 can be used depending on the desired container form factor and energy requirements for the materials in question. For some applications involving materials with extremely high viscosity it is possible that a conventional AC power source 168 may be necessary to supply sufficient energy. For most applications, however, battery power 164 (in the form of standard batteries or rechargeable batteries) is sufficient to provide useful results for the bulk of liquids and containers. Note that the vibrational energy need only be sufficient to cause movement of the material, and accordingly is not likely to cause damage to the container.

The energy/frequency settings can be used to generate sufficient and optimal energy to the container to induce flow of liquid therein. The particular amplitude, frequency, time, etc., can be adjusted and set as well through control knobs/dials 144 using a control circuit 160 to accommodate different sized containers and different types of liquids. For example, the settings for removing mayonnaise from a plastic container may be significantly different than those used for removing mustard from a glass container. By enabling different controllable settings, material can be extracted from a wide number of consumer perishable items.

FIGS. 4A and 4B show an embodiment of a housing and control circuit that can be utilized in the present embodiments. The panel 146 of FIG. 4B depicts controls in the form of switches, dials, knobs, etc. 144 that are presented on the spine 140. In preferred embodiments the user can alter a number of parameters of the vibration apparatus, including an amplitude (A) of the vibrations, a frequency/mode (F) of the vibrations, a time (T) for the vibrating operation, and a heat intensity (H) used by the heating elements. It will be understood that the placement of the controls, the types of controls, and their specific implementation form can be varied in accordance with any desired form factor. For example some controls may be omitted for simplicity and cost reasons, and they may be placed in different parts of the apparatus for convenience (e.g. an on/off switch).

FIG. 4A identifies the basic components of the activator circuit that controls the vibration and heating of containers. This includes a power source (AC/DC) 162 which could be sourced from conventional AC power 168, discrete battery power 164 (e.g. batteries) and/or rechargeable batteries. In some instances, as noted below, power can be supplied by a companion device (e.g. a food processor, refrigerator) that integrates the vibration apparatus functionality. Energy is provided to the container directly through vibration elements 152 and optionally heating elements 154, which may be included in the base, sleeve, cap, and/or strap structures as discussed above. Electrical connections for supplying control and/or power to these elements can be routed through these structural components as well.

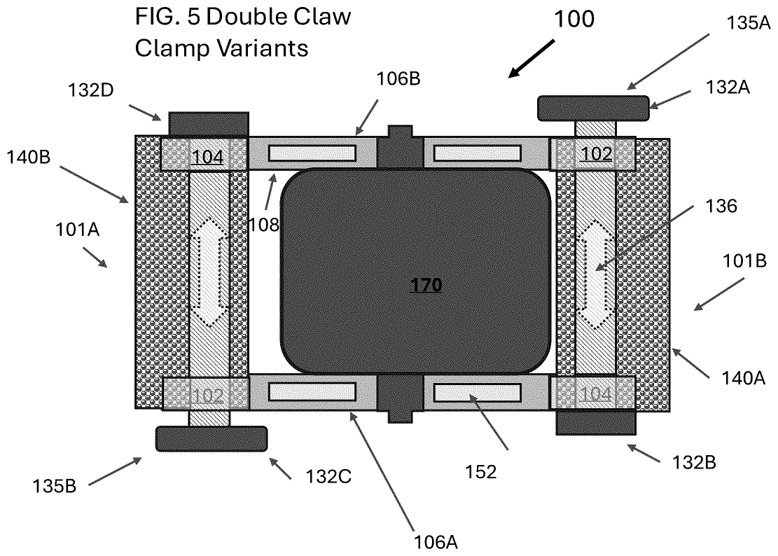

FIG. 5 depicts a variant of the first embodiment of an energizable clamp which includes a pair of opposing clamp members 101A and 101B for securing a container 170. This embodiment effectively is a dual symmetric form of first embodiment with equivalent structures on the left and right that are interlocked and connected through finger members 106A and 106B. In this arrangement the finger elements 106A/106B are arranged to span between the two clamp members 101A/101B, so that an operator can independently tighten and fasten a container securely with two separate and independent screw locking mechanisms. This configuration affords greater and more even pressure of the finger element 106 contact to surfaces of container 170 and may be preferable for some applications. The apparatus 100 is symmetric and thus stable as a result of the opposing body members 140A and 140B, and thus can be placed without additional support on a surface to surround and treat container 170.

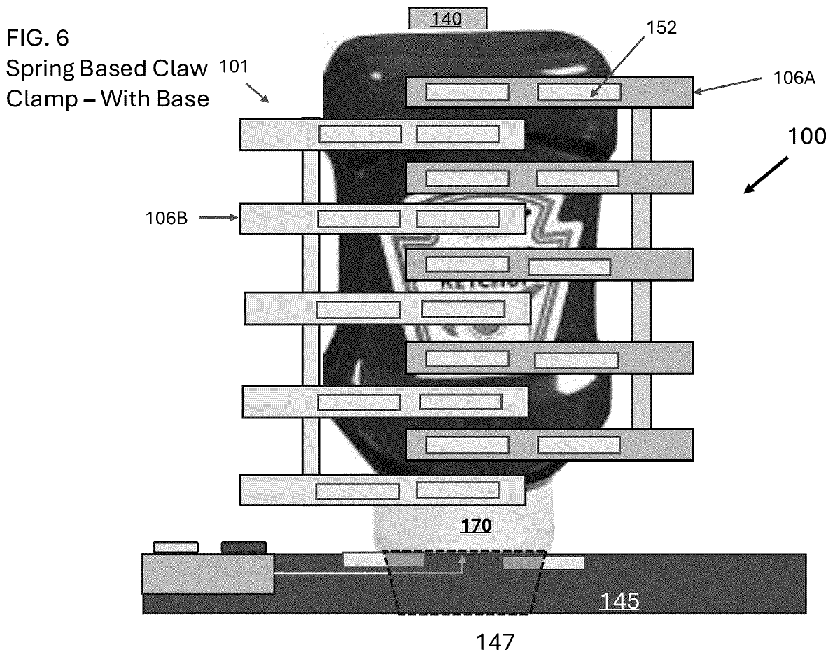

FIG. 6 illustrates a variant of the second embodiment which includes an optional base structure 145 with additional embedded vibrating elements for enhancing a vibration process to extract fluid. A recess structure 147 can also be incorporated within base 145 to receive and stabilize a neck portion of container 170.

Note that while some prior art containers are specifically designed to be left upside down in a storage position to make dispersal of material easier (e.g. usually through pressure induced by squeezing the container) this technique and suffers from the fact that the constituent materials in many food condiments (ketchup, mustard) tend to separate over time. This means that when the container is removed from a refrigerator, the first volume of material that flows is typically lower viscosity material that has separated, such as water, vinegar, etc. This alters the composition of the remaining material and often results in soggy food items as well. To counter this problem users typically have to manually shake the containers to homogenize the material, and this has the effect of redistributing the contents in unfavorable positions along the sidewalls, and necessitating again a series of manual manipulations to coax the material cleanly out of the end of the bottle/container.

FIG. 7A shows a structural overlay of the active elements (including vibrational and optional heating elements) of the flexible wrap liquid extraction apparatus engaging with surfaces of the container during an activation mode to move material therein. The vibration elements 152 and heating elements 154 are shown isolated and activated in a cut-away cross section or plane 175 as they would be present at a surface of the sidewalls of the container 170.

FIG. 7B shows the movement of material in sidewalls of the container during an activation mode. The result of the activation process is that the material is dislodged and made free to move in the direction of the arrow 177 induced by gravity.

FIG. 7C visually depicts the migration and change of position of material 180 in a container 170 over time as effectuated by embodiments of the disclosure, and associated changes in light detection as a result thereof. In embodiments of the present disclosure fluid 180 can be removed in a first time from the container using an energized activation mode that is significantly shorter than a time required for a gravity or passive treatment of the container. The volume of fluid can be removed continuously and smoothly from the container during the activation mode and without additional human supplied energy or force applied to the container.

In some implementations an automatic shut-off mode can be effectuated through an optical sensor that detects changes in the transparency of the container, as seen in FIG. 5E. A sensor/detection pair 153a/153b are mounted on spines 140/142 with one active directed light source providing a reference light beam passing through the container, which is detected by a second passive detector on the opposite side. In an auto timing mode, the intensity of the received light beam is measured at the beginning of the cycle, and changes are detected over time by the controller circuit shown in FIG. 4A. The auto shut off mode could be implemented by any number of factors, such as by noting an absolute change in light intensity over time (e.g. if the amplitude increases by a factor of X in a period T to signify the movement of material from that area), and/or by noting that the light intensity has not appreciably changed in a prior period T (to signify that no further progress can be made using the current settings). It will be appreciated that any desired range of auto operational modes can be implemented depending on the required operational requirements and cost constraints. For high value liquids where it is desirable to extract the maximum amount of material the cost of a detector may be justified.

This process is shown visually in FIG. 7C as well. The fluid 180 is concentrated at a bottom 171 of the container before the activation mode is enabled. Light (from a diode or similar source 153a—see FIG. 5E) is substantially blocked and attenuated so that a received amplitude or intensity at a light detector 153b (see FIG. 5E) is comparatively small. As material 180 is dislodged during a vibrational energy delivery process, it flows down sidewalls 172 to a top portion 173 and cap 174 of container 170. The light measured at T=T4 by the light detector 153B is thus higher, signifying that the material has indeed been moved from portion 171 of the container. This measurement can be used to effectuated an automated mode which the user can simply select through the control panel and cause the apparatus to automatically shut off after the material is detected as dislodged, or some predetermined, controlled time thereafter. Other variations will be apparent to those skilled in the art; for example multiple light sources 153a and detectors 153b may be used to measure intensity at different vertical slices or heights of the container 170. An auto-shut off mode may be used when the opposite condition occurs, namely, the amount of light changes from high to low in a top section 173 of container 170.

The end result of a vibration process as shown in FIG. 7C is that the material 180 is dislodged and collects in the neck 173 or cap 174 of the container 170 where it can be more conveniently removed or retrieved. In some instances the containers are already adapted to use pressure to expel the contents, and therefore the invention facilitates this process by concentrating the material in the most useful region of the container. In some applications the prior art caps or attachments (see FIG. 10C) can be employed to further increase the ease and amount of material removed. That is, the apparatus 100 of the present invention can bring about a more rapid and complete distribution of the material to the end of the container where it can be efficiently removed using one of these prior art devices.

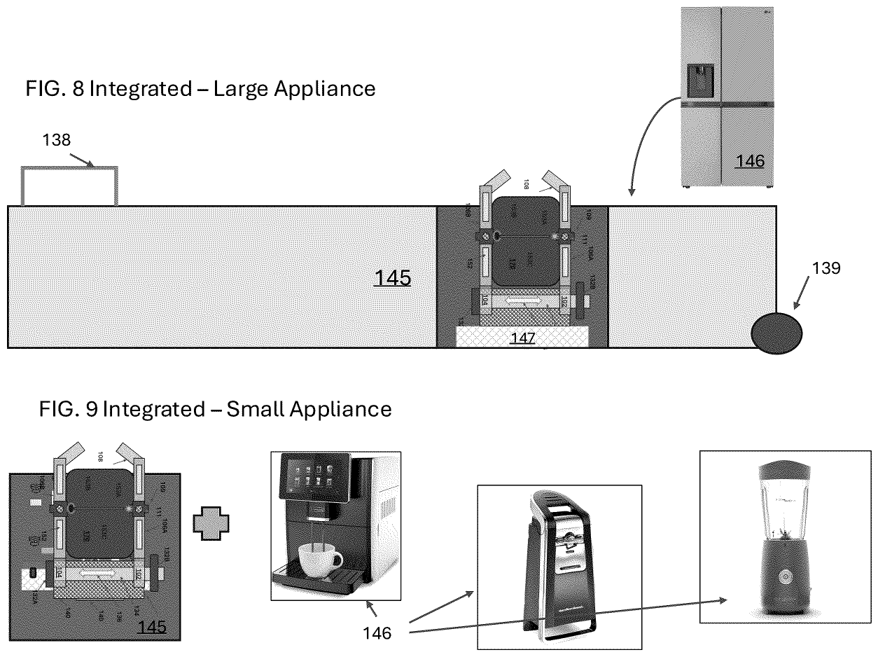

FIGS. 8 and 9 depicted alternative embodiments in which the key features of the invention are integrated into large and small appliances (which perform other typical kitchen household functions, such as refrigeration) respectively. In FIG. 9, the embodiment of FIG. 2C for example is incorporated into a large appliance 146, such as a refrigerator. A refrigerator door 145 with a hinge 139 to a refrigerator body 146 operates as a form of “base” or shelf as seen in the earlier embodiments, including a solid section 147 which operates as a tower in the same manner as the aforementioned FIG. 2C embodiments. The other elements of the FIG. 9 embodiment taken from FIG. 2C (or another elements) are the same. This configuration allows for the apparatus 100 to utilize common structural elements of a large appliance 146 to reduce size, cost, etc. For example apparatus 100 can be incorporated as part of a refrigerator door 145 with a handle 138. Other possible locations within a large appliance will be apparent to those skilled in the art. The extraction apparatus is thus conveniently implemented close to and part of an appliance that is a storage device for the containers that typically would receive treatment to dislodge and remove material.

Note that the embodiment disclosed herein is superior to the prior art techniques, including 1) passive gravity approaches (which take too long and are not forceful enough for some materials); 2) manual force (which is inefficient, uncontrolled and simply spreads the material around in the container); 3) fitted attachments (see FIG. 10C) which similarly rely solely on manual force or passive gravity. The benefits of using low power active vibrational energy include faster, more effective movement of the fluid into a region of the container where it can be more easily and efficiently removed on a comparative volume basis. In other words, embodiments of the invention allow for a recovery of a greater amount of existing volume of material present in the container.

It will be understood by those skilled in the art that the above descriptions are merely examples and that countless variations of the invention can be implemented in accordance with the present teachings. A number of other conventional structures that would be included in a commercial product have been omitted, as well, to better emphasize the present teachings. It is understood that the protection afforded the present invention also comprehends and extends to embodiments different from those above, but which fall within the scope of the claims presented below.

What is claimed is:

1. An apparatus for assisting in dislodgement and movement of a volume of fluid within a solid container, which container has a first bottom end and a second top end comprising:
a. a base structure adapted for housing power and control circuitry;
b. a clamp assembly attached to the base structure and situated in a substantially vertical orientation, said clamp assembly including at least a first body member and a second body member opposing said first body member;
wherein said clamp assembly includes a screw mechanism adapted to cause said two opposing body members to contact and secure the solid container between them;
c. one or more energy delivery finger structures attached to and/or forming part of said first and second body members and configured to contact one or more surfaces of the solid container;
wherein said energy delivery finger structures include:
i. a first set of one or more vibration elements situated in said first body member, which first vibration elements are activatable by electric energy supplied by said power and control circuitry;
said first body member being further adapted to make contact with and position said vibration elements in proximity to a first container surface;
ii. a second set of one or more vibration elements situated in said second body member, which second vibration elements are activatable by electric energy supplied by said power and control circuitry;
said second body member being further adapted to make contact with and position said second vibration elements in proximity to a second first container surface;
wherein the apparatus includes an activation mode enabled by electrical power, during which activation mode the apparatus can apply sufficient vibrational energy to the container through at least one of the first container surface and second container surface to assist and facilitate movement of the volume of fluid from a first bottom end of the container to a second top end of the container.

2. The apparatus of claim 1 further including heating elements incorporated within at least one of said first body members and adapted to heat a surface of the solid container.

3. The apparatus of claim 1 wherein the clamp assembly is adapted with channels and/or conduits to route electrical wiring for said power and control circuitry.

4. The apparatus of claim 1 wherein said electrical control circuit is adapted to control at least one of an amplitude and frequency of vibrations generated by said one or more vibration elements.

5. The apparatus of claim 1 wherein the volume of fluid can be removed in a first time from the container using said activation mode that is shorter than a second time required for a gravity or passive treatment of the container.

6. The apparatus of claim 1 wherein the volume of fluid can be removed continuously and smoothly from the container during said activation mode.

7. The apparatus of claim 1 wherein substantially all the volume of fluid can be removed from the container during said activation mode without additional human supplied energy or force applied to the container.

8. The apparatus of claim 1 wherein the first body member is comprised of a plurality of said energy delivery finger structures connected through strut members to form a movable and adjustable claw that can partially surround and secure the solid container in a fixed position.

9. The apparatus of claim 1 further including a handle for allowing an operator to engage and manipulate the screw mechanism.

10. The apparatus of claim 1 further including solid reverberation elements incorporated within the energy delivery finger structures to enhance the delivery of vibrational energy to the container.

11. The apparatus of claim 1 wherein the energy delivery finger structures are multisegmented and include a hinge for adjusting a spatial relationship of such segments.

12. The apparatus of claim 1 wherein the base structure is sized to contact a top portion of the solid container and delivery vibrational energy to the same through a third set of vibration elements.

13. The apparatus of claim 1, wherein the solid container can be placed in an opposite orientation in the wrap so as to cause movement and compaction of said fluid in a first bottom end of the container.

14. The apparatus of claim 1 wherein the vibration elements are substantially thinner than said flexible finger member and are planar shaped

15. The apparatus of claim 1 wherein the vibration elements are rectangular solid shaped.

16. The apparatus of claim 1 wherein the clamp assembly includes a first clamp and a second clamp connected by joint energy delivery finger structures spanning a space between them, and configured to secure and jointly perform an energy delivery operation on a solid container situated between them.

17. The apparatus of claim 1 wherein said clamp assembly and energy delivery are integrated as part of an appliance that performs other functions.

18. An apparatus for assisting in dislodgement and movement of a volume of fluid within a solid container, which container has a first bottom end and a second top end comprising:
a. a base structure adapted for housing power and control circuitry;
b. a clamp assembly attached to the base structure and situated in a substantially vertical orientation, said clamp assembly including at least a first body member and a second body member opposing said first body member;
wherein said clamp assembly includes a spring mechanism adapted to bias said two opposing body members to make contact and secure the solid container between them;
c. one or more energy delivery finger structures attached to and/or forming part of said first and second body members and configured to contact one or more surfaces of the solid container;
wherein said energy delivery finger structures include:
i. a first set of one or more vibration elements situated in said first body member, which first vibration elements are activatable by electric energy supplied by said power and control circuitry;
°said first body member being further adapted to make contact with and position said vibration elements in proximity to a first container surface;
ii. a second set of one or more vibration elements situated in said second body member, which second vibration elements are activatable by electric energy supplied by said power and control circuitry;
°said second body member being further adapted to make contact with and position said second vibration elements in proximity to a second first container surface;
wherein the apparatus includes an activation mode enabled by electrical power, during which activation mode the apparatus can apply sufficient vibrational energy to the container through at least one of the first container surface and second container surface to assist and facilitate movement of the volume of fluid from a first bottom end of the container to a second top end of the container.

19. The apparatus of claim 18 wherein the spring mechanism includes a spring in contact with a first wing member and a second wing member, which wing members are connected to said two opposing body members, and configured such that an operator can manipulate the two wing members and cause the energy delivery finger structures to clasp and/or release the solid container.
